(19) United States
(12) Patent Application Publication
(10) Pub. No.: US 2009/0134324 A1
(43) Pub. Date: May 28, 2009

(54) Partitions for Forming Separate Vacuum-Chambers

(75) Inventors: Douglas J. King, Union City, CA (US); Thomas Patrick Doherty, San Mateo, CA (US); Jeffrey Thomas Kernan, Santa Cruz, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/364,527

(22) Filed: Feb. 3, 2009

(51) Int. Cl. B01D 59/44; H01J 49/00

(52) U.S. Cl. 250/282; 250/281

(57) ABSTRACT

A mass spectrometry system comprises a panel movable between an open and closed position relative to a housing. At least part of ion-optics is mounted to the panel. The housing surrounds ion-optics and a partition forms a gas barrier separating vacuum-chambers within the housing when the panel is in the closed position. The gas barrier formed by the partition is broken when the panel moves to the open position.

### BACKGROUND OF THE INVENTION

Mass spectrometry is an analytical technique that identifies the chemical composition of a sample based on the mass-to-charge ratio of charged particles. A sample comprises charged particles or undergoes fragmentation to form charged particles. The ratio of charge to mass of the particles is calculated by passing them through electric and magnetic fields in a mass spectrometer.

FIG. 1 shows an example of ion-optics 100 of a typical triple quadrupole mass spectrometer system. The ion-optics 100 of a mass spectrometer has three mains modules: an ion source 101, which transforms the molecules in a sample into ions 113; a mass analyzer 103, which sorts the ions 113 by their masses by applying electric and magnetic fields; and a detector 105, which measures the value of some indicator quantity and thus provides data for calculating the abundances of each ion present.

In the case of a triple quadrupole mass spectrometer, the mass analyzer 103 has a linear series of three quadrupoles. A first quadrupole 107 and a third quadrupole 111 act as mass filters. A middle quadrupole 109 is included in a collision cell. This collision cell is an RF only quadrupole (non-mass filtering) using Ar, He or N₂ gas to induce fragmentation (collision induced dissociation) of selected precursor ions from the first quadrupole 107. Subsequent fragments are passed through to the third quadrupole 111 where they may be filtered or scanned fully.

Any combination of the components 101-111, along with any other components through which the ions 113 pass when traveling from the ion source 101 to the detector 105, such as lenses 115, 117, 119 for steering the ions 113, can be referred to as the ion-optics 100.

Mass spectrometry has both qualitative and quantitative uses, such as identifying unknown compounds, determining the isotopic composition of elements in a compound, determining the structure of a compound by observing its fragmentation, quantifying the amount of a compound in a sample, studying the fundamentals of gas phase ion chemistry (the chemistry of ions and neutrals in a vacuum), and determining other physical, chemical, or biological properties of compounds.

The use of the three quadrupoles allows for the study of fragments (product ions) which are crucial in structural elucidation. For example, the first quadrupole 107 may be set to “filter” for a drug ion of a known mass, which is fragmented in the middle quadrupole 109. The third quadrupole 111 can then be set to scan the entire m/z range, giving information on the sizes of the fragments made. Thus, the structure of the original ion can be deduced.

It is often desirable to have a pressure differential along the length of the ion-optics 100. This can be done by positioning different parts of the ion-optics 100 in separate separate vacuum chambers having different pressures. There are several reasons why this pressure differential along the length of the ion-optics 100 is desirable.

Most mass analyzers, such as the mass analyzer 103, work best at low pressure. This is because lower pressure means there will be fewer collisions with other gas molecules, resulting in a higher probability that an ion 113 will make it all the way from the ion source 101 to the detector 105. Additionally, the lenses 115, 117, 119 for steering the ions 113 work just like the simulation models predict at low pressure, but less so at higher pressure. Furthermore, high voltages are less likely to cause gas to break down at lower pressures.

Most ion sources, such as the ion source 101, on the other hand, work best using a higher concentration or pressure of the molecule being measured (the analyte). The more analyte there is, the more that is ionized, and the more that gets measured.

Thus, it is desirable to have a higher pressure at the source 101 and a lower pressure at the analyzer 103. Separate vacuum chambers along the length of the ion-optics allow for this differential pressure.

The separate vacuum chambers are also helpful because gas is pumped into the middle quadrupole 109 collision cell, and the differential pressure prevents the gas pumped into the collision cell from entering the ion source 113. Collision cell gas entering the ion source 113 would be undesirable since the goal is to increase the pressure of the desired pure analyte, not that of the collision cell gas.

U.S. Pat. No. 6,069,355 to Mordehai describes a mass spectrometer having three separate vacuum chambers (labeled as 111, 112, 113 in FIG. 1 of Mordehai) providing a pressure differential along the path of the ion beam (see FIG. 1 and column 3, lines 10-30 of Mordehai). However, Mordehai uses standard vacuum connections, making it very difficult and time consuming to access or remove components internal to the vacuum chambers, and thus assembly and disassembly, for periodic maintenance, is difficult.

U.S. Pat. No. 5,753,795 to Kuypers describes a setup for providing easier access and removal of mass spectrometer components internal to a vacuum chamber. A demountable, high-vacuum plate assembly (labeled as 44 in FIG. 3 of Kuypers), is provided for accessing mass spectrometer components internal to a vacuum chamber (labeled as 66 in FIG. 4 of Kuypers). However, Kuypers only provides access to a single vacuum chamber. It does not provide any teaching of how to access or remove mass spectrometer components positioned in several separate vacuum chambers such as the three vacuum chambers of Mordehai.

It would be desirable to provide fast and convenient access to mass spectrometer components passing thorough multiple vacuum chambers.

### BRIEF DESCRIPTION OF THE DRAWINGS

Further preferred features of the invention will now be described for the sake of example only with reference to the following figures, in which:

FIG. 1 is a schematic diagram illustrating ion-optics of a typical triple quadrupole mass spectrometer system.

FIG. 2 is an isometric cutaway view showing a portion of a mass spectrometry system of an embodiment of the present invention.

FIG. 3 is an isometric view including ion-optics and a partition of FIG. 2, but as they would appear with the panel in the closed position.

FIG. 4 is a cross-sectional view of the mass spectrometry system of FIG. 2, including the housing, panel and stage seal, but with the ion-optics and bracket omitted to provide a better view of the position of the stage seal when the panel is in the closed position relative to the housing.

FIG. 5 shows a multi-piece embodiment of the stage seal which can be used as the stage seal illustrated in FIGS. 2, 3 and 4.

FIG. 6 shows an embodiment of the stage seal having an inflatable section which can be used as the stage seal illustrated in FIGS. 2, 3 and 4.

FIG. 7 illustrates the removal of the ion optics shown in FIGS. 2-4.

FIG. 8 is a flow chart identifying steps for operating vacuum-chambers when using the mass spectrometer system of FIG. 2.

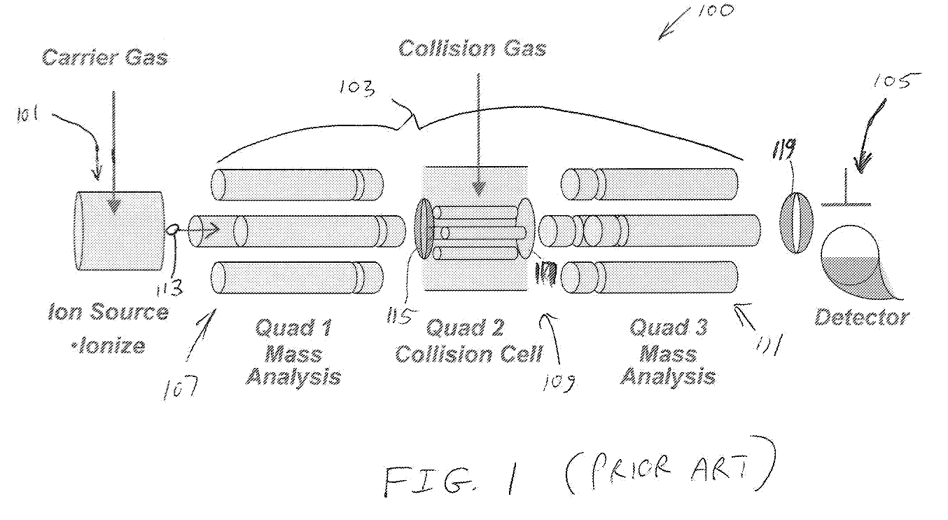

### DETAILED DESCRIPTION

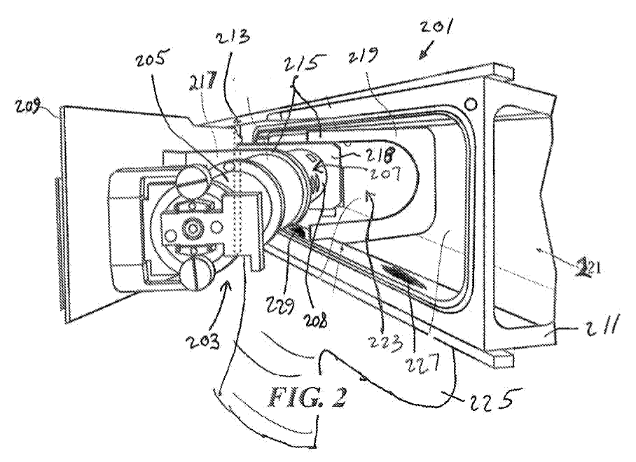

FIG. 2 is an isometric cutaway view showing a portion of a mass spectrometry system 201 of an embodiment of the present invention. Ion-optics 203 are mounted to a panel 209 using a bracket 217 and a bracket 218. An ion source 205 and a first quadrupole mass filter 207 (the first quadrupole mass filter 207 is within the cylindrical shroud 208) of a mass analyzer of the ion-optics 203 are shown. The middle quadrupole collision cell, third quadrupole mass filter and detector of the ion-optics 203 are omitted in this figure.

The panel 209 is connected to a housing 211 via a hinge 213. The panel 209 rotates about the hinge 213 when moving between an open and a closed position relative to the housing 211. When the panel 209 is in the closed position, the housing 211 surrounds the ion-optics 203. In FIG. 2, the panel 209 is shown in an open position relative to the housing 211.

Although the panel 209 is described as being open or closed by rotating the panel 209 about the hinge 213, alternately, the panel 209 can be opened or closed by sliding it into the open or closed position, or in other ways as would be appreciated by those skilled in the art.

At least a portion of the ion-optics 203 is mounted to the panel 209. However, another portion of the ion-optics 203 might not be mounted to the panel 209. For example, the ion source 205 and the first quadrupole mass filter 207 might be mounted to the panel 209, while the middle quadrupole collision cell, third quadrupole mass filter and detector of the ion-optics 203 might be mounted to another panel or to the housing 211.

In other embodiments, different devices, including electron microscopes, sample handlers for electron microscopes, surface science equipment, and wafer loaders may be mounted to the panel 109. Electronic subassemblies may also be mounted on the panel 109.

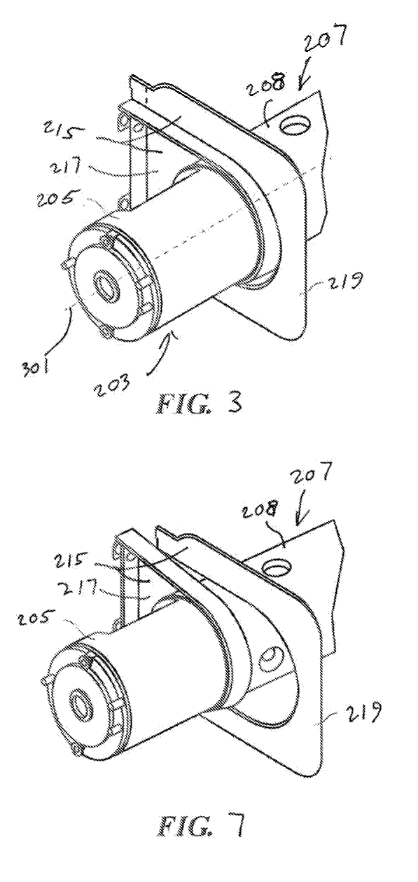

FIG. 2 additionally shows a multi-piece partition 215 formed from the bracket 217 and a stage seal 219. FIG. 3 also shows the multi-piece partition 215 as in FIG. 2, but with the panel 209 in the closed position. In order to provide a better view, the housing 211 and panel 209 are omitted from the illustration of FIG. 3. The partition 215 forms a gas barrier located between the ion source 205 and the first quadrupole mass filter 207 so that these components are within separate vacuum-chambers 221, 223 within the housing 211. The partition 215, when the panel 209 is in the closed position, is generally directed transversely to a beam-axis 301 of the ion-optics 203. The gas barrier formed by the partition 215 is broken when the panel 209 is moved to an open position such as that illustrated in FIG. 2.

FIG. 4 is a cross-sectional view of the mass spectrometry system 201 of FIG. 2 including the housing 211, panel 209 and stage seal 219, but with the ion-optics 203 and bracket 217 omitted to provide a better view of the position of the stage seal 219 when the panel 209 is in the closed position relative to the housing 211. The stage seal 219 can be seen to include an inner seal 403 along an edge of the stage seal 219. The inner seal 403 reduces any gap between the stage seal 219 and bracket 217 of the partition 215, therefore reducing the amount of gas that might pass through such a gap. A central U-shaped channel 401 formed in the stage seal 219 allows the ion-optics 203 to slide in and out. The stage seal 219 is shown to form a close fit to an inner wall of the housing 211.

In general, the partition 215 can be any structure forming a gas barrier to create the vacuum chambers 221 and 223 within the housing 211 when the panel 209 is in the closed position. Also, the stage seal 219 can be any portion of the partition 215, or the stage seal 219 might even form the entire partition 215. The “stage seal” helps provide the gass-barrier seal between stages, or vacuum chambers.

The partition 215 can be formed from a single or multiple pieces. In the example of FIG. 2, the partition 215 includes the stage seal 219 in combination with the bracket 217. In the example of FIG. 4, the stage seal 219 also includes a separate piece, the inner seal 403.

As illustrated in FIG. 3, the bracket 217 of the partition 215 fits against the ion-optics 203 and the bracket 217 also fits against the stage seal 219. Similarly, as illustrated in FIG. 4, the stage seal 219 fits against inner walls of the housing 211.

In other embodiments, the partition 215 can include the stage seal 219 without use of the bracket 217, thereby providing a single-piece embodiment of the partition 215. The stage seal 219 of the partition 215 then fits directly against the ion-optics 203 and against inner walls of the housing 211. The stage seal 219 can be fixed to the ion-optics 203 so that it separates from the inner walls of the housing 211 when the panel 209 is opened. Alternatively, the stage seal 219 can be fixed to the inner walls of the housing 211 so that it separates from the ion-optics 203 when the panel 209 is opened. The stage seal 219 can be fixed to the ion-optics 203 or inner walls of the housing 211 using any method known to those skilled in the art, such as by using an adhesive, soldering, welding, or by machining it as a single piece with the ion-optics or housing.

FIG. 5 shows a multi-piece embodiment of the stage seal 219 which can be used as the stage seal of FIGS. 2, 3 and 4. The stage seal 219 is shown having the inner seal 403 and also an outer seal 501. The inner seal 403 can fit against the bracket 217, or directly against the ion-optics 203, to help make the partition 215 a barrier to gas. The outer seal 501 can similarly fit against inner walls of the housing 211 to help make the partition 215 a barrier to gas. In other embodiments the inner seal 403, the outer seal 501 or both can be omitted from the stage seal 219. The inner seal 403, outer seal 501, or the entire stage seal 219 can be made of an adhesive or elastomeric material. In general, the seals 403, 501 can be made of any material or combination of materials which improves the gas barrier between the vacuum-chambers 221, 223 within the housing 211 when the panel 209 is in the closed position.

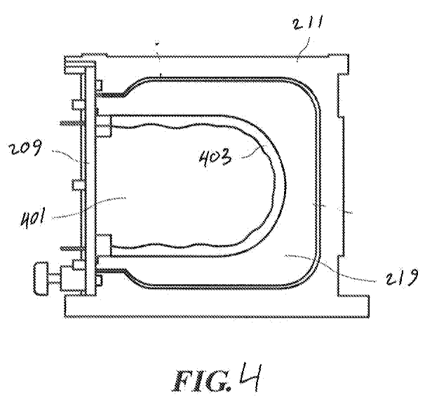

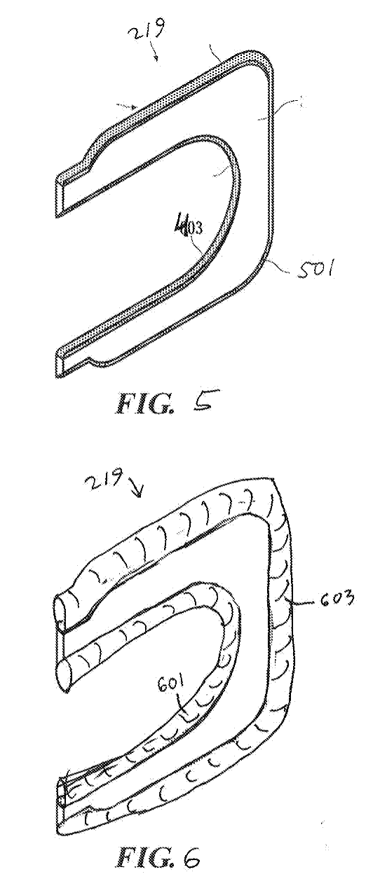

FIG. 6 shows another embodiment of the stage seal 219 which can be used as the stage seal of FIGS. 2, 3 and 4. The stage seal 219 is shown having an inflatable inner seal 601 and also an inflatable outer seal 603. More generally, these inflatable inner and outer seals can be any type of inflatable section of the partition as would be understood by those skilled in the art. The inflatable seals 601, 603 improve the gas barrier between the vacuum-chambers 221, 223 within the housing 211 when the panel 209 is in the closed position and the housing 211 is under vacuum. When the pressure surrounding the inflatable seals 601, 603 is lowered (when the chambers 221, 223 of the housing 211 are pumped-down), the inflatable seals 601, 603 expand to create a seal against the other parts of the partition 215, inner walls of the housing 211 or ion-optics 203.

The inner seals 601, 603 or generally the inflatable section, are bags trapping gas inside. When the pressure outside these bags is less than the pressure of the gas within the bags, the bags will expand. Similarly, as the pressure outside of these bags increases, the bags contract. In other embodiments a material in a phase other than the gas phase can be trapped within the bags so long as it expands and contracts in response to pressure changes.

When the panel 203 is opened relative to the housing 211, bringing the chambers 221, 223 to ambient pressure, the inflatable seals 601, 603 contract enough to allow the stage seal 241 to be easily separated from the ion-optics 203 or from the other portions of the partition 215. In other embodiments the inflatable section of the partition can be affixed to the partition 215, inner wall of the housing 211 or ion-optics 203. In yet another embodiment, the entire stage seal 219 of FIG. 6 or the entire partition 215 of FIG. 3 can be an inflatable section. The inflatable section can be made of a balloon or other flexible material. It can be, for example, be a gas-filled bladder.

The partition 215 or the stage seal 219 or any other portion of the partition 215, can remain fixed relative to the ion-optics 203 and the panel 209 when opening and closing the panel 209, or can remain fixed relative to a wall of the housing 211. In FIG. 2, for example, the stage seal 219 of the partition 215 remains fixed relative to a wall of the housing 211 when the panel 209 is moved to the open position. In the example of FIG. 2, it can also be said that part of the partition 215 (the stage seal 219) remains fixed relative to a wall of the housing 211 and part of the partition 215 (the bracket 217) remains fixed relative the ion-optics 203 and the panel 209. In contrast, FIG. 3 can be used to illustrate the position of the stage seal 219 of the partition 215 if it were to remain fixed relative to the ion-optics 203 and the panel 209 when opening and closing the panel 209.

It should be noted that the gas barrier formed by the partition 215 is not necessarily a vacuum seal. It can be designed to provide any degree of isolation between the vacuum-chambers 221, 223 that is needed. In some applications, the partition 215 might allow for a pressure-differential between the chambers 221, 223 with one of the chambers remaining at ambient pressure. The partition 215 can even have gaps in it, allowing gas to pass from one vacuum-chamber 221 to the other vacuum-chamber 223, as long as it serves as a barrier to some of the gas.

In some embodiments the partition 215 can be selectively permeable, allowing some types of gas to pass between the chambers 221, 223 while blocking other types of gas, or allowing different types of gas to pass through at different rates.

To achieve this type of gas barrier, the stage seal 219 can be made of materials such as a rubber, plastic, ceramic or metal, as would be understood by those skilled in the art.

While only a single partition 215 forming two chambers 221, 223 is illustrated, more than one partition can be used to create two or more chambers as would be understood by those skilled in the art. For example, three partitions identical to the partition 215 can be used to create four separate chambers within the housing 211. The ion-optics 203 could then pass through all of these partitions to experience four different pressures along its length.

In addition to the partition 215 separating the ion source 205 and the first quadrupole mass filter 207 of a mass analyzer portion of the ion-optics 203, a second partition might separate the middle quadrupole collision cell from the first quadrupole mass filter 207. A third partition might separate the middle quadrupole collision cell from the third quadrupole mass filter. A fourth partition might separate the third quadrupole mass filter from the detector of the ion-optics 203. Thus, the ion source 205, first quadrupole mass filter 207, middle quadrupole collision cell, third quadrupole mass filter, and detector can all be in separate chambers formed by the four partitions.

A method for operating the vacuum-chambers 221, 223 within the housing 211 of the mass spectrometry system 201 is now described with reference to the flowchart of FIG. 8, along with FIGS. 2-7.

At STEP 801, with the panel 209 in an open position, the stage seal 219 can be placed in contact with either inner walls of the housing 211 (as shown in FIG. 2) or else in contact with the bracket 217 (as shown in FIG. 3) or directly with the ion-optics 203. This placement of the stage seal 219 can be done manually by an operator.

At STEP 803 the panel 209 is closed relative to the housing 211 of the mass spectrometry system 201 so that a gas barrier is formed by the partition 215 to create separate vacuum-chambers 221, 223 within the housing 211.

As shown in FIG. 2, when the panel 209 is closed relative to the housing 211, the bracket 217 and the stage seal 219 of the partition 215 slide together into position between the ion-optics 203 and inner walls of the housing 211, thereby forming the gas barrier. Again, FIG. 3 more clearly shows the position of the bracket 217 and the stage seal 219 forming the partition 215 when the panel 209 is in the closed position. FIG. 4 more clearly shows the position of the stage seal 219 and inner walls of the housing 211 when the panel 209 is in the closed position.

At STEP 805 the pressure in the vacuum-chambers 221, 223 is pumped down. Referring to FIG. 2, a vacuum pump 225 differentially pumps-down the vacuum-chambers 221, 223 through vacuum pump ports 227, 229, respectively, passing through walls of the housing 211.

The vacuum pump 225 can have a pumping rate of 2.5 m³/hr, for example, and might pump-down the pressure of the vacuum-chamber 221 to a pressure of 5.0×10⁻⁴ Torr and pump-down the pressure of the vacuum-chamber 223 to a pressure of 5.0×10⁻⁵ Torr. The differential pumping can thus provide a differential pressure between the vacuum-chambers of at least a factor of ten (10) or greater when needed.

In an embodiment with multiple partitions and more than two vacuum-chambers, additional vacuum pump ports can be included through walls of the housing 211.

At STEP 807, after the vacuum chambers are pumped down, the mass spectrometry system 201 can be used to perform a measurement on a sample.

The measurement of a sample can be performed by ionizing the sample using the ion source 205 to transform the molecules in the sample into ions. Gas, such as helium, is also pumped into the source 205. Most of the ions are passed through a hole in the partition 215. However, any un-ionized gas that would compromise the performance of the mass analyzer is pumped away. The mass analyzer portion of the ion-optics 203 then sorts the ions by their masses by applying electric and magnetic fields. The detector of the ion-optics 203 measures the value of some indicator quantity and thus provides data for calculating the abundances of each ion present.

The measurement of the sample can be used for identifying unknown compounds, determining the isotopic composition of elements in a compound, determining the structure of a compound by observing its fragmentation, quantifying the amount of a compound in a sample, studying the fundamentals of gas phase ion chemistry (the chemistry of ions and neutrals in a vacuum), and determining other physical, chemical, or biological properties of compounds making up the sample.

When maintenance is required, at STEP 809 the vacuum-chambers 221, 223 are re-pressurized by allowing air at ambient or near-ambient pressure to enter the chambers 221, 223 through the vacuum pump ports 227, 229 or through other vents providing access to the inside of the housing 211.

At STEP 811 the panel 209 is opened so that the gas barrier formed by the partition 215 is broken. FIG. 2 shows the partition 215 separated into its separate bracket 217 and a stage seal 219 parts to break the gas barrier.

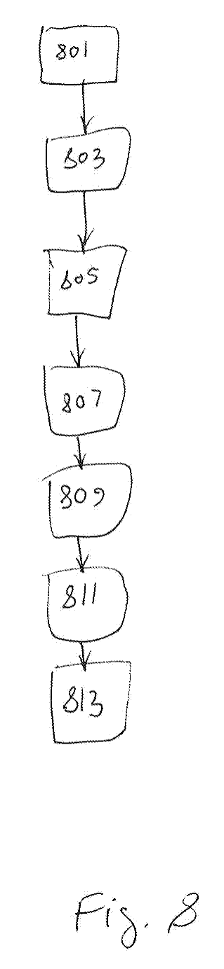

At STEP 813 it is a simple matter for a user to manually remove the stage seal 219 as shown in FIG. 7. Thus, mass spectrometer components internal to the vacuum chamber of the housing 211, for example the ion-optics 203, can easily be accessed or removed for supportability.

In the foregoing specification, the invention has been described with reference to specific exemplary embodiments thereof. The specification and drawings are, accordingly, to be regarded in an illustrative sense rather than a restrictive sense.

1. A mass spectrometry system comprising:
a housing;
a panel movable between an open and closed position relative to the housing;
ion-optics, at least part of which is mounted to the panel, wherein the ion-optics are surrounded by the housing and the panel when the panel is in the closed position;
a partition forming a gas barrier separating vacuum-chambers within the housing when the panel is in the closed position;
and,
the gas barrier formed by the partition is broken when the panel moves to the open position.

2. The system of claim 1, wherein the panel rotates about a hinge when moving between the open and closed positions.

3. The system of claim 1, wherein at least a portion of the partition remains fixed relative to the ion-optics and the panel when the panel is moved to the open position.

4. The system of claim 1, wherein at least a portion of the partition remains fixed relative to a wall of the housing when the panel is moved to the open position.

5. The system of claim 1, wherein the partition slides into position between the ion-optics and the housing when the panel is moved from the open to the closed position.

6. The system of claim 1, wherein the partition forms a gas barrier directed transversely to a beam-axis of the ion-optics when the panel is in the closed position.

7. The system of claim 1, wherein the partition includes an elastomeric material for creating the gas barrier.

8. The system of claim 1, wherein the partition includes an inflatable section creating the gas barrier upon pumping down the pressure in the housing.

9. The system of claim 1, wherein in a closed and pumped-down state, the separate vacuum-chambers have pressures differing by at least a factor of ten (10).

10. The system of claim 1, wherein the partition is formed of multiple pieces.

11. A method for operating vacuum-chambers within a housing of a mass spectrometry system comprising the steps of:
closing a panel relative to the housing of the mass spectrometry system so that a gas barrier is formed by a partition to create separate vacuum-chambers within the housing;
pumping down the pressure in the vacuum-chambers;
performing a measurement with the mass spectrometry system;
re-pressurizing the vacuum-chambers; and
opening the panel so that the gas barrier formed by the partition is broken.

12. The method of claim 11, wherein the step of opening or closing the panel comprises rotating the panel about a hinge.

13. The method of claim 11, wherein during the step of opening the panel, a portion of the partition remains fixed relative to the ion-optics and the panel.

14. The method of claim 11, wherein during the step of opening the panel, a portion of the partition remains fixed relative to a wall of the housing.

15. The method of claim 11, wherein the step of closing the panel further comprises sliding the partition into position between the ion-optics and housing.

16. The method of claim 11 wherein, upon closing the panel, the partition forms a gas barrier directed transversely to a beam-axis of the ion-optics.

17. The method of claim 11, wherein the partition includes an elastomeric material for creating the gas barrier.

18. The method of claim 11, wherein upon pumping down the pressure, an inflatable section of the partition expands to create the gas barrier.

19. The method of claim 11, wherein, upon closing the panel, the partition creates the separate vacuum-chambers to allow different pressures in each upon pumping down the pressure in the separate vacuum-chambers.

20. The method of claim 11, wherein the step of pumping down the pressure in the vacuum-chambers further comprises pumping the pressure down so that the separate vacuum-chambers have pressures differing by at least a factor of ten.
